(19) United States
(12) Patent Application Publication
(10) Pub. No.: US 2009/0303023 A1
(43) Pub. Date: Dec. 10, 2009

(54) Rfid Tag for Train Wheels

(76) Inventor: Albertus Jacobus Pretorius, Kungwini (ZA)

Correspondence Address: NIXON & VANDERHYE, PC, 901 NORTH GLEBE ROAD, 11TH FLOOR, ARLINGTON, VA, 22203, US

(21) Appl. No.: 12/227,607

(22) PCT Filed: May 22, 2007
(86) PCT No.: PCT/IB2007/051923

§ 371 Date: Jul. 15, 2009

(30) Foreign Application Priority Data
May 23, 2006 (ZA) 2006/04136

(51) Int. Cl. B60Q 1/00; G08B 17/00; H04Q 5/22

(52) U.S. Cl. 340/425.5; 340/584; 340/10.1

(57) ABSTRACT

A tag 12.1 for a vehicle comprises collar 32 adapted to be fitted on an axle of the vehicle. The collar carries an RF transponder 20.1 comprising transponder circuitry and an antenna 40. The circuitry is connected to a sensor 44 for a parameter associated with the assembly in use. The circuitry is responsive to cause the transponder to transmit a first radio frequency signal when a value of the parameter exceeds a threshold value.

### INTRODUCTION AND BACKGROUND

This invention relates to radio frequency identification (RFID) systems and more particularly to a tag, system and method for detecting and transmitting data relating to a parameter relating to a wheel assembly of a vehicle, such as a rail vehicle.

A known problem associated with the wheels of rail vehicles, such a train, is that due to bearing failure etc, the wheels may become too hot, or, may change shape over a period of time. Should any of these situations occur, advance warning is required to take remedial action, such as to stop the train, to limit damage. Detection systems are known, but they all suffer from one or the other disadvantage, such as that initial capital investment may be too high, they are difficult and costly to maintain, prone to damage and not reliable enough.

### OBJECT OF THE INVENTION

Accordingly, it is an object of the present invention to provide an RFID tag for a vehicle wheel assembly, a detection system comprising at least one such a tag and associated methods, with which the applicant believes the aforementioned disadvantages may at least be alleviated.

### SUMMARY OF THE INVENTION

According to the invention there is provided a tag for a vehicle, the tag comprising a carrier configured to be fitted on a wheel and axle assembly of the vehicle, the carrier carrying a radio frequency (RF) transponder comprising transponder circuitry and an antenna, the circuitry being connected to a sensor for a parameter associated with the assembly in use and being responsive to cause the transponder to transmit a first RF signal when a value of the parameter exceeds a threshold value.

The vehicle is preferably a rail vehicle and the carrier may comprise a collar, which is configured to be mounted on an axle of the assembly.

The collar may comprise a first collar part and a second collar part adapted to be connected to one another, thereby to close the collar and to mount the collar on the axle. The collar may be substantially circular in configuration, the first collar part may comprise a first circle segment part and the second collar part may comprise a second and complementary circle segment part, the first and second parts may be hinged to one another at respective first ends of the parts and may be releasably connectable to one another at respective opposite ends of the parts by a releasable link.

The first and second parts may be made from any suitable material, such as a suitable resinous material.

The parameter may be at least one of temperature, vibration frequency and any other parameter relating to at least part of the assembly in use.

At least part of the circuitry may be integrated on an application specific integrated circuit (ASIC).

The antenna and circuitry may be provided in a radially outward region of the collar and the sensor may be provided in a radially inward region of the collar.

Hence in use, when the tag is mounted on the axle, the chip and antenna are spaced from the axle by part of the carrier body and the sensor is in closer proximity to the axle.

The sensor may comprise an element, such as a loop, of a suitable conductive material, which loop is configured such that the loop changes resistance at a predetermined threshold temperature, and wherein the circuitry is configured to sense the change and in response thereto, to transmit said first RF signal.

The first RF signal preferably comprises data relating to an identification code associated with the tag.

Also included within the scope of the present invention is a monitoring system comprising at least one tag as herein defined and/or described; and at least one associated reader adapted to be mounted in proximity of a railway, to be in communication with the transponders on the tags.

Still further included within the scope of the invention is a method of monitoring a parameter associated with a wheel and axle assembly in use, comprising the steps of:
utilizing a sensor connected to a radio frequency transponder to sense for a change in a parameter associated with the assembly in use; and
in response to the change, causing the transponder to transmit a first radio frequency signal to a reader.

### BRIEF DESCRIPTION OF THE ACCOMPANYING DIAGRAMS

The invention will now further be described, by way of example only, with reference to the accompanying diagrams wherein

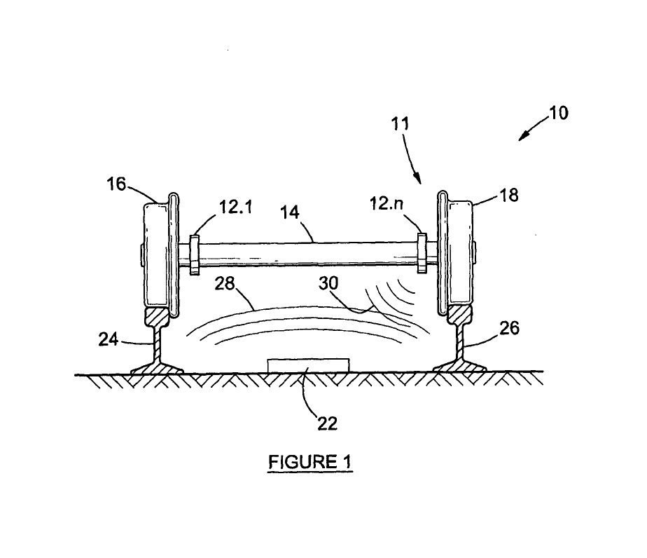

FIG. 1 is a diagrammatic front elevation of a wheel and axle assembly of a rail vehicle and a monitoring system according to the invention comprising a tag according to the invention;

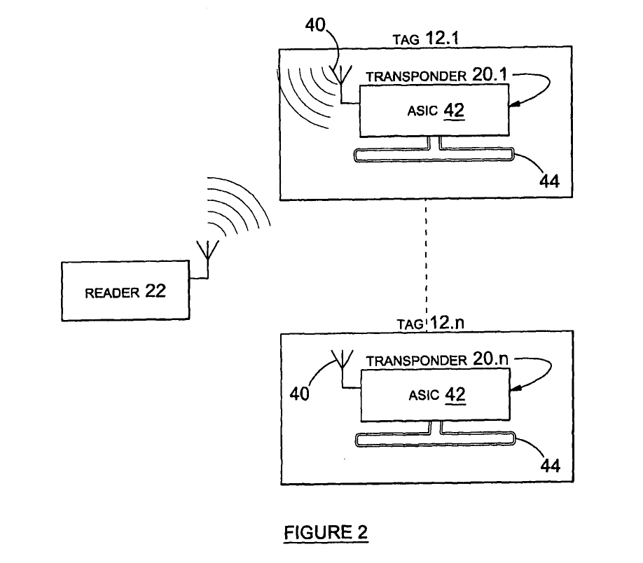

FIG. 2 is a basic block diagram of the monitoring system according to the invention;

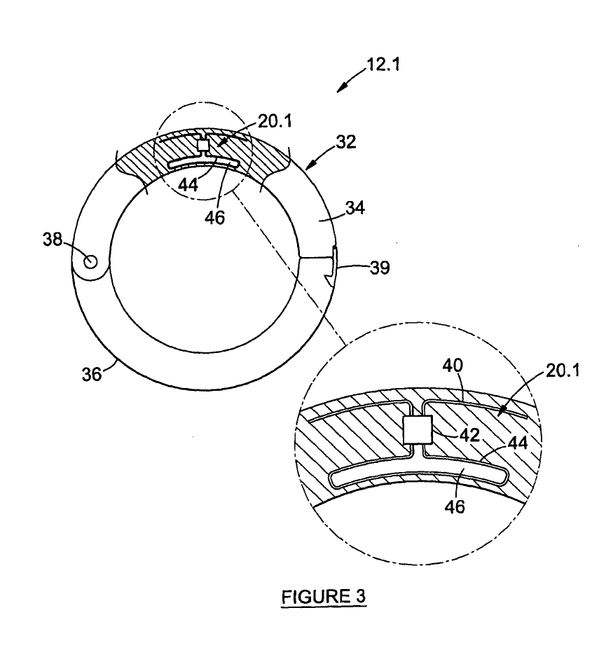

FIG. 3 is a front elevation of the tag according to the invention, partially in section; and

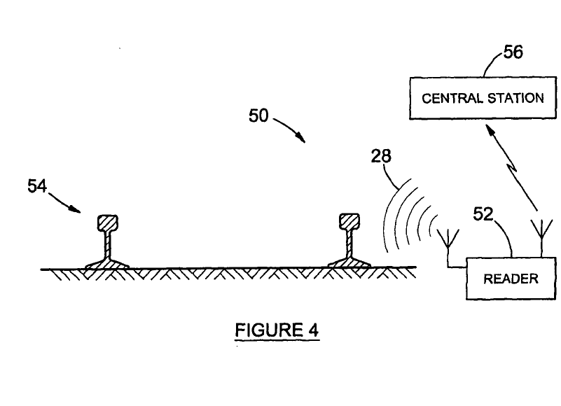

FIG. 4 is an alternative embodiment of the system according to the invention.

### DESCRIPTION OF A PREFERRED EMBODIMENT OF THE INVENTION

A monitoring system for monitoring a parameter associated in use with a wheel and axle assembly of a vehicle, such as a rail vehicle, is generally designated by the reference numeral 10 in FIG. 1.

The system comprises a plurality of tags 12.1 to 12.n adapted to be mounted on a rail vehicle wheel and axle assembly 11, comprising an axle 14 and opposed wheels 16 and 18. Each tag comprises a radio frequency transponder 20.1 to 20.n respectively, as will hereinafter be described. The system 10 further comprises a reader 22 mounted between rails 24 and 26 for reading response signals transmitted by the transponders in use. As illustrated in FIGS. 1 and 2, in use, the reader 22 intermittently transmits an energizing or interrogating radio frequency signal 28. The transponders derive in known manner energy from the energizing signal and transmit, by way of backscatter modulation, a respective first response signal 30 to be received by the reader 22, as will hereinafter be described in more detail.

The transponders may be passive transponders deriving energy as aforesaid, alternatively they may be active transponders, each comprising a suitable power source (not shown).

The tags 12.1 to 12.n are similar in configuration and therefore tag 12.1 only will now further be described with reference to FIG. 3. The tag 12.1 comprises an openable and closeable collar 32 adapted to be mounted on the axle 14. The collar comprises a first circle segment part 34 and a second complementary circle segment part 36 hinged to the first part at respective first ends 38 of the parts.

A suitable link or clip mechanism 39 at respective second ends of the parts enables the openable and closable collar selectively to be opened, alternatively to be closed. The parts are made of a suitable resinous material. The first part 34 carries the transponder 20.1. The transponder 20.1 comprises an antenna 40 connected to electronic circuitry integrated on a single ASIC 42. The circuitry is connected to a sensor 44 for a parameter relating to the assembly, in use. The parameter is selected from temperature, vibration frequency and any other parameter relating to at least part of the assembly in use. The parameter, in turn, is dependent, for example, on distortion in shape of the wheel. In the embodiment shown, the sensor comprises an element, such as a loop 44 of an electricity conductive material selected and configured such that it would rupture or change in resistance at a predetermined threshold temperature.

The transponder is typically embedded in the first part 34 with the loop located in a cavity 46 defined in the first part. As shown in FIG. 3, the antenna 40 and chip 42 are preferably located in a radially outward region of the collar 32 and the cavity 46 with loop 44 in a radially inward region, so that, in use, it is located in as close as possible proximity to and suitable heat communication relationship with the axle 14.

The circuitry may be configured such that the transponder only transmits the first response signal and that is when the loop 44 is interrupted. The first signal preferably comprises data and the data preferably comprises an ID code associated with the tag 12.1 and hence axle 14 and preferably wheel 16.

Hence, should the bearings of the wheel fail, the resulting heat generated will cause the temperature of the axle 14 in the region of the wheel 16 to rise. When the temperature reaches the threshold value, the loop 44 ruptures or changes resistance, causing the transponder to transmit the first signal. The signal and data backscatter modulated thereon are read by the reader 22, to identify the tag 20.1, axle 14 and wheel 16. The data may be used immediately to brake the train or to take any other suitable remedial step.

In other embodiments, the transponders may be configured to transmit a second signal until the threshold value is reached. In the case of a passive transponder, upon being energized the transponder responds with the second signal, unless the threshold value has been reached in which event the transponder responds with said first signal.

In the embodiment 50 shown in FIG. 4, a plurality of readers 52 are positioned in spaced relation alongside the railway 54. Data derived from the tags may be collected as they pass the readers and forwarded to a central station 56 for processing and analyses. The data may be used to detect hot wheels as aforesaid or changes in vibrating frequency, which may be indicative of changes in the shape of the wheels.

1. A monitoring system for a wheel and axle assembly of a rail vehicle on a railway comprising at least one tag comprising a carrier configured to be fitted on the wheel and axle assembly of the rail vehicle, the carrier carrying a radio frequency (RF) transponder comprising transponder circuitry, an antenna and a sensor for a parameter associated with the assembly in use connected to the circuitry and being responsive to cause the transponder to transmit a first RF signal when a value of the parameter exceeds a threshold value; at least one associated reader positioned alongside the railway, the system being configured such that the first signal is received by the at least one reader alongside the railway.

2. A monitoring system as claimed in claim 1 wherein the carrier comprises a collar configured to be mounted on an axle of the assembly.

3. A monitoring system as claimed in claim 2 wherein the collar comprises a first collar part and a second collar part adapted to be connected to one another, thereby to close the collar and to mount the collar on the axle.

4. A monitoring system as claimed in claim 3 wherein the collar is substantially circular in configuration, wherein the first collar part comprises a first circle segment part and the second collar part comprises a second and complementary circle segment part wherein the first and second parts are hinged to one another at respective first ends of the parts and are releasably connectable to one another at respective opposite ends of the parts by a releasable link.

5. A monitoring system as claimed in claim 1, wherein the parameter is at least one of temperature, vibration frequency end any other parameter relating to at least part of the assembly in use.

6. A monitoring system as claimed in claim 1, wherein the circuitry is Integrated on a chip.

7. A monitoring system as claimed in claim 4, wherein the antenna and circuitry are provided in a radially outward region of the collar and the sensor is provided in a radially inward region of the collar.

8. A monitoring system as claimed in claim 5 wherein the parameter is temperature and wherein the sensor comprises a loop of a suitable conductive material, which loop is configured such that the loop changes resistance at a predetermined threshold temperature, and wherein the circuitry is configured to sense the change end in response thereto, to transmit said first RF signal.

9. A monitoring system as claimed in claim 1, wherein the first RF signal comprises data relating to an identification code associated with the tag.

10. A monitoring system as claimed in claim 1, wherein the at least one associated reader intermittently transmits an interrogation radio frequency signal and wherein the transponder responds with the first signal when the value of the parameter exceeds the threshold value.

11. A method of monitoring a parameter associated with a wheel and axle assembly of a rail vehicle in use on a railway, the method comprising the steps of: utilizing a sensor connected to a radio frequency transponder to sense for a change in a parameter associated with the assembly in use; and in response to the change, causing the transponder to transmit a first radio frequency signal to be received by an associated reader provided alongside the railway.

12. A method as claimed in claim 11 wherein the first signal is transmitted in response to an interrogation signal transmitted by the reader.
